(19) United States
(12) Patent Application Publication
(10) Pub. No.: US 2025/0350836 A1
(43) Pub. Date: Nov. 13, 2025

(54) IMAGING SYSTEM

(71) Applicant: Panasonic Intellectual Property Management Co., Ltd., Osaka (JP)

(72) Inventors: Satoshi MATSUI, Kyoto (JP); Norikazu KATSUYAMA, Osaka (JP)

(21) Appl. No.: 19/277,726

(22) Filed: Jul. 23, 2025

Related U.S. Application Data
(63) Continuation of application No. PCT/JP2024/001621, filed on Jan. 22, 2024.

(30) Foreign Application Priority Data
Jan. 25, 2023 (JP) 2023-009557

(51) Int. Cl. H04N 23/68; G03B 5/00; G03B 30/00; G06T 5/73; H04N 23/57

(52) U.S. Cl. CPC H04N 23/683; G03B 5/00; G03B 30/00; G06T 5/73; H04N 23/57; H04N 23/6812; H04N 23/685; G03B 2205/0023; G06T 2207/20201

(57) ABSTRACT

An imaging system mounted on a moving object and capturing an image of an imaging target that is at least a part of surroundings of the moving object apart from the moving object includes an imager, a blur corrector, and an image processor. The imager captures images of the imaging target over time to acquire a plurality of images. The blur corrector acquires movement information of the moving object to correct blur along a movement direction that occurs in each of the plurality of images during exposure of the imager. The image processor calculates a pixel movement amount of a common area in the plurality of images. The blur corrector corrects blur along the movement direction during exposure when the imager captures a next image, based on the movement information and on the pixel movement amount acquired from the image processor.

### CROSS REFERENCE TO RELATED APPLICATION

This is a continuation application of International Application No.PCT/JP2024/001621, with an international filing date of Jan. 22, 2024, which claims priority of Japanese Patent Application No.2023-009557 filed on Jan. 25, 2023, the content of which is incorporated herein by reference.

### BACKGROUND

### Technical Field

The present disclosure relates to an imaging system that corrects blur in response to movement of a moving object.

### Background Art

As transportation infrastructure ages, there is an increasing demand for infrastructure inspection. Instead of visual inspection by humans, the efficiency of inspection can be improved dramatically by capturing images of infrastructure facilities while moving with a mobile vehicle and by detecting defects through image processing of the captured images. However, because the image is captured while moving, the captured images are subject to blurring.

For example, in WO2015060181, blurring caused by camera movement during exposure is corrected using saccade mirror technology. The blurring is reduced by irradiating light onto a subject to be imaged and allowing the light reflected by the imaging subject to be reflected by a mirror rotating for a preset exposure time and then enter the camera.

Blur correction requires the movement velocity of the moving object during blur correction, but it is difficult to detect the movement velocity of the moving object with high accuracy, which may lead to deterioration in blur correction if the movement velocity cannot be detected accurately.

### SUMMARY

The present disclosure provides an imaging system that suppresses deterioration in blur correction even when capturing images while moving.

An imaging system disclosed herein is an imaging system mounted on a moving object and capturing an image of an imaging target that is at least a part of surroundings of the moving object apart from the moving object includes an imager, a blur corrector, and an image processor. The imager captures images of the imaging target over time to acquire a plurality of images. The blur corrector acquires movement information of the moving object to correct blur along a movement direction that occurs in each of the plurality of images during exposure of the imager. The image processor calculates a pixel movement amount of a common area in the plurality of images. The blur corrector corrects blur along the movement direction during exposure when the imager captures a next image, based on the movement information and on the pixel movement amount acquired from the image processor.

According to the imaging system of the present disclosure, there can be provided an imaging system that suppresses deterioration in blur correction even when imaging while moving, as well as a moving object including the imaging system.

### BRIEF DESCRIPTION OF DRAWINGS

FIG. 1 is a diagram showing a vehicle including an imaging system.

FIG. 2 is a diagram showing a configuration of the imaging system according to an embodiment.

FIG. 3 is an explanatory view explaining blur correction in the imaging system.

FIGS. 4A and 4B are explanatory views explaining an image captured without blur correction during exposure.

FIG. 5 is an explanatory view showing a subject distance in the embodiment.

FIGS. 6A and 6B are explanatory views explaining movement of a characteristic part in images captured in successive imaging frames.

FIG. 7 is a flowchart showing the action of an image processor of a first embodiment.

FIG. 8 is a flowchart showing a blur correction process according to the first embodiment.

FIGS. 9A to 9D are graphs showing the relationship between changes in movement velocity, timings of exposure time, and movement blur correction angles in the first embodiment.

FIGS. 10A and 10B are explanatory views showing the relationship between changes in the movement velocity and captured images in the first embodiment.

FIGS. 11A to 11D are graphs showing the relationship between changes in movement velocity, timings of exposure time, captured images, and output timings of pulse signals in a second embodiment.

FIG. 12 is a flowchart showing a blur correction process performed by an imaging system of the second embodiment.

FIG. 13 is a flowchart showing a blur correction process performed by the imaging system of the second embodiment.

FIG. 14 is a flowchart showing the action of an image processor of the second embodiment.

FIG. 15 is a flowchart showing a blur correction process performed by an imaging system of a third embodiment.

FIG. 16 is a flowchart showing a blur correction process performed by the imaging system of the third embodiment.

FIG. 17 is a flowchart showing a blur correction process performed by an imaging system of a fourth embodiment.

### DETAILED DESCRIPTION

### First Embodiment

A first embodiment will now be described with reference to the drawings. In the first embodiment, a case will be described where the moving object is a vehicle 3 such as an automobile, with an imaging system 1 being attached to an upper part of the vehicle 3.

### 1. Configuration of Imaging System

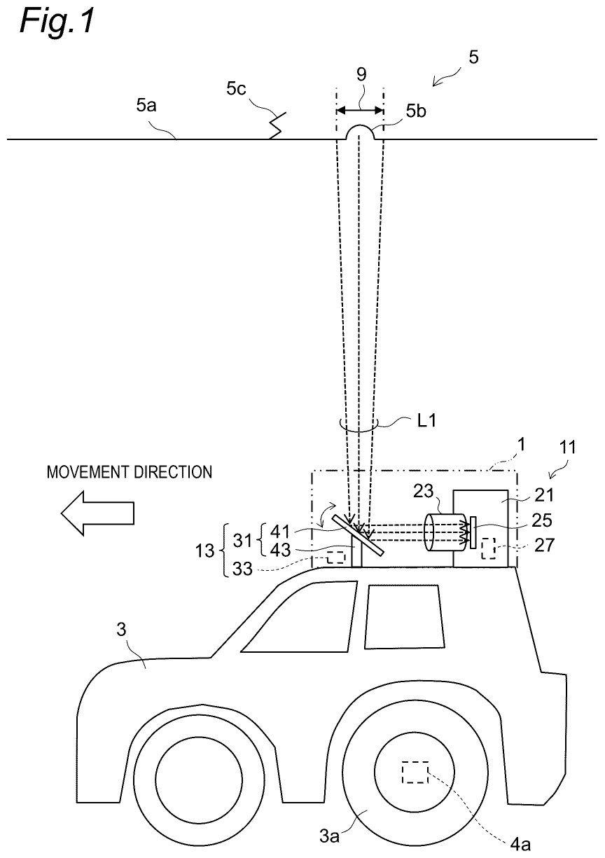

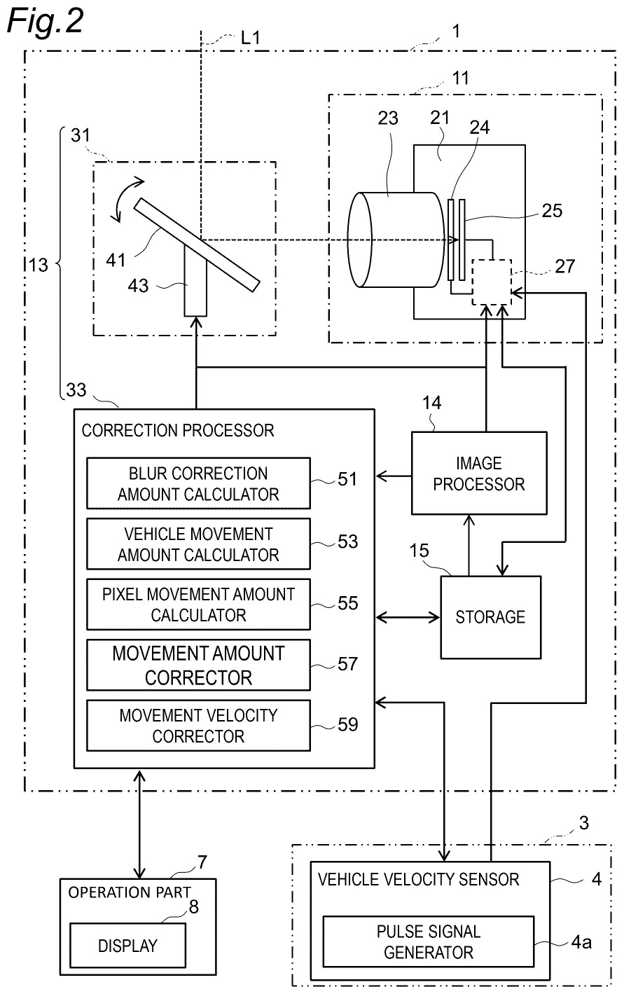

Reference is made to FIGS. 1 and 2. FIG. 1 is a diagram explaining the imaging system 1. FIG. 2 is a block diagram showing an internal configuration of the imaging system 1. In FIG. 1, the vehicle 3 is traveling, for example, through the interior of a tunnel 5. For example, a hole 5b and a crack 5c appear on a wall surface 5a in the tunnel 5.

An imaging target of the imaging system 1 is at least a part of a structure around the vehicle 3 and is a target that moves relatively depending on the movement velocity of the vehicle 3 as the vehicle 3 moves. An imaging target area 9 is an area of this imaging target that is acquired as an image. The imaging target may be not only the inner wall of the tunnel 5 but also the side or bottom of an overpass, utility poles, and electric wires. This makes it possible to detect holes, cracks, lifting, peeling, joints, tilt of utility poles, and bending of electric wires in the imaging target from the acquired image through image processing.

The vehicle 3 includes tires 3a and a vehicle velocity sensor 4 that detects the movement velocity of the vehicle 3. The vehicle velocity sensor 4 has a pulse signal generator 4a that outputs a pulse signal every time an axle supporting the tires 3a rotates a fixed amount. In other words, the pulse signal generator 4a outputs a pulse signal every time the vehicle 3 travels a first vehicle movement amount Lp that is a fixed distance. The first vehicle movement amount Lp is standardized and determined in advance.

The imaging system 1 is installed on an upper surface of the vehicle 3. In FIG. 1, the imaging system 1 is fixed so as to capture an image of a structure above the vehicle 3, for example, the wall surface 5a of the tunnel 5, but it may be installed so as to capture an image of the wall surface 5a on the side or diagonal side of the vehicle 3. The imaging system 1 may also capture an image of a road surface below the vehicle 3. Potholes, cracks, ruts, and the like that have occurred on the road surface can be detected from the captured image through image processing.

The imaging system 1 includes an imager 11, a blur corrector 13, an image processor 14, and a storage 15. The imager 11 captures images of structures around the vehicle 3, and when the vehicle 3 travels through the tunnel 5, for example, captures an image of the wall surface 5a of the tunnel 5. The imager 11 includes a camera body 21, a lens 23 as an optical lens, a shutter 24, an imaging element 25, and a camera controller 27. The imager 11 sets an imaging interval so that a common area is captured in a plurality of captured images.

The camera body 21 has the lens 23 replaceably attached thereto, and houses the imaging element 25 and the camera controller 27. The imaging element 25 is disposed at a position corresponding to a focal length F of the lens 23. The imaging element 25 is a solid-state imaging element, such as a CCD imaging element, a CMOS imaging element, or an infrared imaging element.

The camera body 21 is disposed on the vehicle 3 so that the orientation of the lens 23 is parallel to the moving direction of the vehicle 3. For example, the camera body 21 is disposed so that the lens 23 faces forward or backward of the vehicle 3. The camera body 21 and the lens 23 may be integrated, for example, as in a video camera, with a blur correction assembly 31 being disposed outside the integrated camera body 21 and lens 23. The camera controller 27 opens the shutter 24 while receiving an exposure instruction signal from a correction processor 33. The shutter 24 may be configured to have a plural-blade diaphragm that opens and closes, or may be an electronic shutter.

The blur corrector 13 corrects the optical path of light entering the imaging system 1 so as to reduce blurring along the movement direction in the image of the imaging target area 9, in other words, positional deviation in the movement direction of the imager 11 relative to the imaging target area 9, even if the imager 11 captures an image while the vehicle 3 is moving. The blur corrector 13 includes the blur correction assembly 31 and the correction processor 33.

The blur correction assembly 31 corrects the optical path of the reflected light L1, which is the ambient light reflected by the imaging target area 9, in accordance with the movement of the vehicle 3. The blur correction assembly 31 includes a mirror 41 and a mirror drive 43 that drives the mirror 41 to rotate. Instead of using a mirror, the blur correction assembly 31 may be a pan-tilt mechanism that drives a lens barrel, in which the lens 23 and the imaging element 25 are integrated, around a rotation axis, for example, in a pan direction and a tilt direction. The pan-tilt mechanism has a drive that drives the integrated lens 23 and imaging element 25 to rotate. The drive is, for example, a motor. The blur correction assembly 31 may have a tilt function that rotates the camera body 21 and the lens 23 in the vertical direction and a pan function that rotates them in the horizontal direction. The blur correction assembly 31 may also be a mechanism that rotates the entire imager 11, or may have an optical lens drive assembly and an imaging element drive assembly. In this way, when blur correction is performed without using a mirror, the lens 23 and the camera body 21 are installed so that the orientation of the lens 23 is perpendicular to the direction of movement of the vehicle 3.

The mirror 41 is arranged to be rotatable so as to face the lens 23. The mirror 41 can be rotated in either the forward or reverse clockwise direction, for example, and the rotatable angle range may be less than 360 degrees or may be 360 degrees or more. The mirror 41 totally reflects the ambient light reflected by the imaging target toward the imaging element 25 of the imager 11. The mirror drive 43 drives the mirror 41 to rotate from an initial angle to an angle designated to correct imaging blur, and returns the mirror 41 to the initial angle after rotating to the designated angle. The mirror drive 43 is, for example, a motor. The rotation angle of the mirror 41 is limited by the mechanical constraints of the mirror drive 43, and the mirror 41 can be rotated up to a maximum swing angle of the mirror 41 determined by this constraint.

The correction processor 33 detects an inter-pulse time Tr from when a pulse signal is output until the next pulse signal is output. As a result, the correction processor 33 calculates a first movement velocity Vp by dividing the first vehicle movement amount Lp by the inter-pulse time Tr. In this way, the correction processor 33 can detect the movement velocity of the vehicle 3 based on the pulse signal of the pulse signal generator 4a. Since the standardized first vehicle movement amount Lp contains an error, the first movement velocity Vp of the vehicle 3 detected based on the pulse signal of the vehicle velocity sensor 4 contains an error. For example, the first movement velocity Vp of the vehicle 3 contains an error of about 6% at most. In addition, the error of the first vehicle movement amount Lp varies depending on the number of occupants of the vehicle 3, the remaining amount of gasoline, weight change due to the weight of the load, and changes in tire air pressure. The first movement velocity Vp of the vehicle 3 detected by the correction processor 33 is displayed on a speedometer of the vehicle 3 to inform the driver of the velocity of the vehicle 3. The pulse signal generator 4a transmits a pulse signal to the correction processor 33. The correction processor 33 calculates the inter-pulse time Tr based on the pulse signal transmitted from the pulse signal generator 4a, and calculates the first movement velocity Vp based on the first vehicle movement amount Lp and the inter-pulse time Tr. The calculation of the inter-pulse time Tr and the first movement velocity Vp may be performed by a vehicle movement amount calculator 53, or may be performed by an arithmetic processor disposed in the vehicle velocity sensor 4.

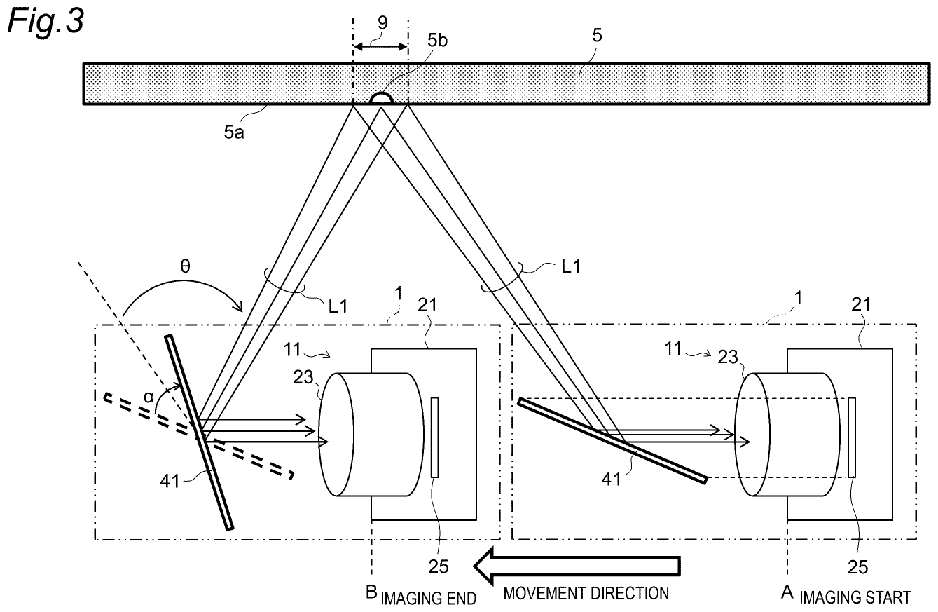

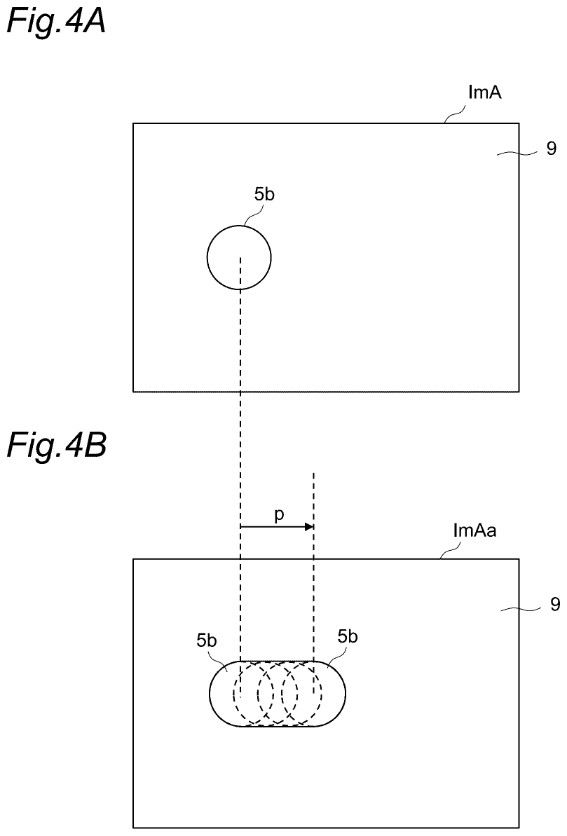

The blur correction by the blur corrector 13 will be described with reference to FIG. 3 and FIGS. 4A and 4B. FIG. 3 is an explanatory view explaining the blur correction in the imaging system 1. FIGS. 4A and 4B show an image captured without blur correction, FIG. 4A shows an image at the timing of the start of imaging, and FIG. 4B shows an image at the timing of the end of imaging.

For example, the imaging system 1 located at position A moves together with the vehicle 3 to position B after an exposure time Tp. Imaging starts at position A, and an image ImA that can be acquired at this timing is shown in FIG. 4A. In the image ImA, for example, the hole 5b in the imaging target area 9 is captured. However, since the exposure time of the image ImA is insufficient, the image is dark and not clear.

Thus, exposure is continued until the vehicle 3 moves to position B. In this case, if no blur correction is performed, the imaging target area 9 moves relatively in the direction opposite to the moving direction of the vehicle 3, resulting in an image ImAa in which the hole 5b has moved relatively, as shown in FIG. 4B. In the image ImAa, the pixel movement amount p is detected as the amount of blur. In this way, the image captured by the imager 11 while the vehicle 3 is moving will be a blurred image.

Thus, by rotating the mirror 41 in a direction in which the end of the mirror 41 in the moving direction cancels out the relative movement of the imaging target during the exposure time according to the movement velocity of the imaging system 1 and the vehicle 3, the imaging system 1 can capture the same imaging target area 9 in the captured image during the exposure time, and obtain an image with significantly reduced blur. The mirror 41 is rotated clockwise in FIG. 1 so that the end of the mirror 41 in the moving direction rotates toward the imaging target during the exposure time. By rotating the mirror 41, the pixel movement amount p is corrected to zero in the image ImAa.

An overview of this embodiment will then be described. As will be described later, the amount of blur correction during exposure changes according to the magnitude of pixel movement of a feature point included in the imaging target from the start to the end of imaging. The pixel movement amount is proportional to the vehicle movement amount as well as a subject magnification M. The subject magnification M is proportional to the focal length F of the lens 23 and inversely proportional to a subject distance D from the imaging element 25 to the imaging target.

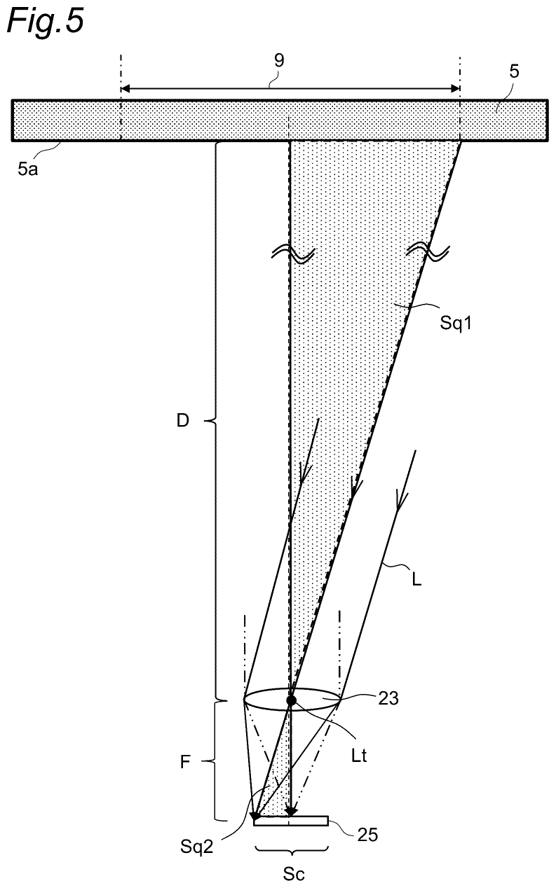

The subject distance D from the imaging element 25 to the image pickup target will be described with reference to FIG. 5. FIG. 5 is an explanatory view showing the subject distance D in this embodiment.

As shown in FIG. 5, the subject distance D[m]is the distance from the principal point Lt of the lens 23 disposed between the imaging target and the imaging element 25 to the imaging target. In this embodiment, the imaging target is the tunnel 5. The distance from the principal point Lt of the lens 23 to the imaging element 25 is the focal length F of the lens 23. The principal point Lt of the lens 23 is not necessarily located at the center of the lens 23 depending on the lens shape of the lens 23 or when the lens 23 is composed of plural lenses, and may be located outside the lens 23.

The range of the imaging target area 9 as the subject size that fits within the angle of view is determined by the ratio of similar figures of two triangular areas Sq1 and Sq2, depending on the subject distance D, the focal length F, and the size Sc[mm]of the imaging element 25 in one direction. When parallel light L from the imaging target area 9 enters the lens 23, it is focused on the imaging element 25.

To correct the vehicle velocity information, for example, the pixel movement amount of the feature point in the image for each imaging interval and the moving distance of the vehicle 3 for each imaging interval are used. The imaging interval may be a time interval or a distance interval. In this embodiment, exposure and imaging are performed in synchronization with pulse updates of the pulse signal output from the vehicle velocity sensor 4, so that imaging is performed at equal distance intervals. Note that instead of synchronizing with pulse updates of the pulse signal, imaging may be performed at a fixed frame rate as in the second embodiment described later.

Referring to FIG. 2, the correction processor 33 controls the blur correction assembly 31 to correct blur. The correction processor 33 includes a blur correction amount calculator 51, the vehicle movement amount calculator 53, a pixel movement amount calculator 55, and a movement amount corrector 57.

The correction processor 33 is a circuit that can be implemented by semiconductor elements or the like. The correction processor 33 can be configured by, for example, a microcomputer, a CPU, an MPU, a GPU, a DSP, an FPGA, or an ASIC. The function of the correction processor 33 may be configured by hardware alone, or may be implemented by combining hardware and software. The correction processor 33 implements a predetermined function by reading data and programs stored in the storage 15 and performing various arithmetic processing.

The blur correction amount calculator 51 calculates a swing angle of the blur correction mechanism during exposure based on the amount of movement of the vehicle 3, the time required for that movement, the exposure time, and the subject distance. The blur correction amount calculator 51 calculates a mirror swing angle a of the mirror 41 during image capture based on, for example, a movement velocity (vehicle velocity) V1 of the vehicle 3, the set exposure time Tp, the subject distance D, and the focal length F of the lens 23 in the following manner.

The movement velocity V1[km/h] is calculated from following Equation (1) using the first vehicle movement amount Lp[mm] and a time T[s] required to move by the first vehicle movement amount Lp.

$$V 1 [ km / h ] = ( Lp [ mm ] / T [ s ] ) \times ( {60}^{2} / {10}^{6} ) \qquad Eq . ( 1 )$$

The vehicle movement amount La of the vehicle 3 during the exposure time Tp from the start of imaging to the end of imaging is calculated from the movement velocity V1 of the vehicle 3 and the exposure time Tp by following Equation (2).

$$La [ mm ] = V 1 [ km / h ] \times {10}^{6} \times Tp [ ms ] / ( {60}^{2} / {10}^{3} ) \qquad Eq . ( 2 )$$

The pixel movement amount p on the imaging element 25 during the exposure time Tp from the start of imaging to the end of imaging is calculated from the vehicle movement amount La of the vehicle 3 and the subject magnification M according to following Equation (3).

$$p [ mm ] = La [ mm ] \times M \qquad Eq . ( 3 )$$

Since this pixel movement amount p causes blurring, in order to prevent blurring, the optical path of the light incident on the lens 23 is changed by a motion blur correction angle θ corresponding to the pixel movement amount p. The motion blur correction angle θ is calculated from the pixel movement amount p and the focal length F by following Equation (4).

$$θ [ deg ] = arctan ( p / F ) \qquad Eq . ( 4 )$$

The subject magnification M is a value determined by the focal length F and the subject distance D according to following Equation (5).

$$M = F [ mm ] / ( D [ m ] \times {10}^{3} ) \qquad Eq . ( 5 )$$

The focal length F is a value determined by the lens 23. The subject distance D may be a value measured in advance, or may be a value measured by a distance measuring sensor while the moving object is moving.

Using Equations (1) to (3) and (5), Equation (4) can be transformed into Equation (6) which follows.

$$θ = arctan ( Lp [ mm ] \times Tp [ ms ] / ( D [ m ] \times T [ s ] \times {10}^{6} ) ) \qquad Eq . ( 6 )$$

Hence, the motion blur correction angle θ is calculated based on the first vehicle movement amount Lp of the vehicle 3, the time T required for that movement, the exposure time Tp, and the subject distance D.

The mirror swing angle α is half the motion blur correction angle θ and therefore is calculated by Equation (7) which follows.

$$α = θ / H \qquad Eq . ( 7 )$$

where the conversion coefficient H is a conversion coefficient between the mirror swing angle α, which is an assembly swing angle of the drive assembly, and the motion blur correction angle θ, which is the optical correction angle at which light incident on the lens 23 is corrected. In the case of a configuration where light from an imaging target travels through the mirror 41, the lens 23, and the imaging element 25 in this order, as in the embodiment of FIG. 1, the conversion coefficient H=2. In addition, in the case of a configuration where the imager 11 and the blur correction assembly 31 are integrated into a pan-tilt mechanism or the entire camera is driven, the conversion coefficient H=1.

In this manner, the blur correction amount calculator 51 calculates the mirror swing angle α of the mirror 41.

Hence, by rotating the mirror 41 in the direction opposite to the direction of movement during exposure, the imager 11 can receive light from the same imaging target area 9 during the exposure time, thereby suppressing motion blur in the captured image.

Other parameters used for blur correction are pixel movement amounts by which feature points move during an imaging interval, which are pixel movement amount pa[px] in pixel units, pixel movement amount pb[mm]in length units, and pixel pitch s[μm/px] of the captured image. The focal length F[mm]of the lens 23 and pixel pitch s[μm/px] of the captured image are predetermined values. In this embodiment, when referring to both pixel movement amount pa in pixel units and pixel movement amount pb in length units, it is simply written as pixel movement amount p.

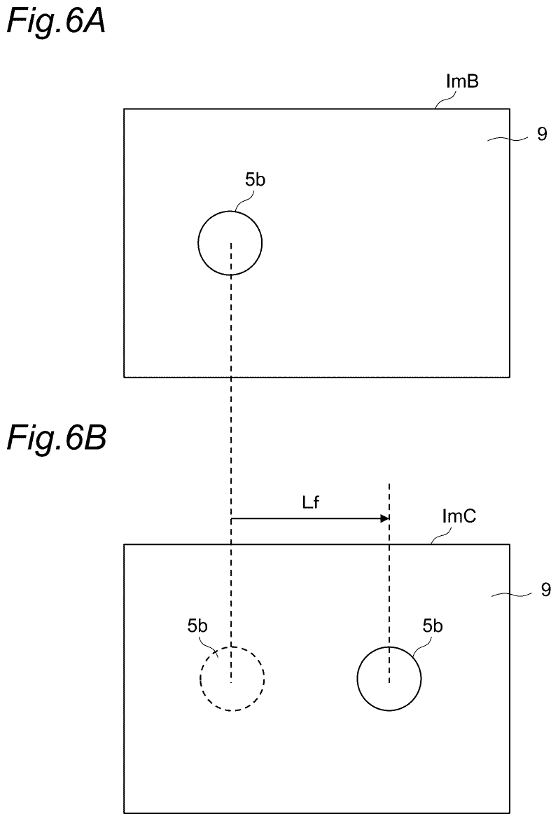

Reference is made to FIGS. 6A and 6B. While FIGS. 4A and 4B show a feature point that moves during imaging, FIGS. 6A and 6B show a captured image ImB of a feature point captured first in an imaging frame at a certain timing, and a captured image ImC of a feature point captured first in the next imaging frame.

The image processor 14 calculates the pixel movement amount of a common feature portion of plural blur-corrected images. The image processor 14 calculates, for example, a pixel movement amount p between the captured frames of a feature point such as the hole 5b by image matching of two captured images ImB and ImC captured in different frames. The pixel movement amount p may be one point in the captured images ImB and ImC, or may be an average value of pixel movement amounts p1, p2, . . . , pn at plural points.

The image processor 14 is an integrated circuit that can be implemented by semiconductor elements or the like. The image processor 14 can be configured by, for example, a microcomputer, a CPU, an MPU, a GPU, a DSP, an FPGA, or an ASIC. The functions of the image processor 14 may be configured by hardware alone, or may be implemented by combining hardware and software. The image processor 14 implements a predetermined function by reading data and programs stored in the storage 15 and performing various arithmetic processing.

In this embodiment, there are three types of vehicle movement amounts La: a first vehicle movement amount Lp obtained based on movement information from the vehicle velocity sensor 4, a second vehicle movement amount Lf obtained by image processing from a plurality of captured images, and a third vehicle movement amount Lc obtained from the first vehicle movement amount Lp and a movement amount correction value calculated based on the first vehicle movement amount Lp and the second vehicle movement amount Lf. The vehicle movement amount calculator 53 calculates these three types of vehicle movement amounts.

In this embodiment, exposure is performed and imaging is performed in synchronization with pulse updates of the pulse signal output from the pulse signal generator 4a. This allows the first vehicle movement amount Lp, which is determined as a standard value of the vehicle velocity sensor, to be the vehicle movement amount of the vehicle 3. The first vehicle movement amount Lp of the vehicle 3 can be directly acquired from the pulse signal. In this case, the first vehicle movement amount Lp is Lp=a. A constant a is a constant value as described above, and is the distance that the vehicle 3 moves until the pulse signal is updated.

However, the first vehicle movement amount Lp determined as a standard value of the vehicle velocity sensor contains an error due to the air pressure of the tires 3a and the load of the vehicle 3. Hence, the vehicle movement amount calculator 53 calculates a third vehicle movement amount Lc of the vehicle 3 during the imaging interval between the two captured images, based on the pulse signal received from the pulse signal generator 4a and the movement amount correction value calculated by the movement amount corrector 57.

The pixel movement amount calculator 55 converts the unit of the pixel movement amount calculated by the image processor 14. For example, the pixel movement amount calculator 55 calculates a pixel movement amount pb in units of length on the order of [mm] from a pixel movement amount pa in units of pixels using a pixel pitch s[μm/px] of the captured image according to following Equation (8).

pb[mm]=pa[px]×s[μm/px]/10³ Eq. (8)

The pixel movement amount calculator 55 may be included in the image processor 14 instead of the correction processor 33, in which case the calculated pixel movement amount pb in length units is output from the image processor 14 to the correction processor 33.

For ease of explanation, the subject distance D, subject magnification M, and pixel resolution X are assumed to be fixed values, but individually detected values may be used.

The pixel movement amount calculator 55 can associate the pixel unit of the captured image with the length unit from the pixel resolution X of the captured image. The pixel movement amount calculator 55 may measure the length of the crack in the captured image, or may store the captured image converted into the length unit in the storage 15.

The vehicle movement amount calculator 53 calculates the second vehicle movement amount Lf between the imaging frames based on the pixel movement amount pb in length units using following Equation (9).

$$Lf [ mm ] = pb [ mm ] \times D [ m ] \times ( 1 / F [ mm ] ) \times {10}^{3} \qquad Eq . ( 9 )$$

Moreover, following Equation (10) is derived from Equations (8) and (9).

$$Lf [ mm ] = pa [ px ] \times s [ μm / px ] \times D [ m ] \times ( 1 / F [ mm ] ) \qquad Eq . ( 10 )$$

In this way, by substituting the pixel movement amount pa calculated from the feature point matching of the two images into Equation (10), the second vehicle movement amount Lf between the frames of the captured images can be calculated.

The movement amount corrector 57 corrects the vehicle movement amount based on the pixel movement amount pb. For example, the movement amount corrector 57 may calculate the second vehicle movement amount Lf, which is a vehicle movement amount obtained by image processing based on the pixel movement amount pa in pixel units calculated by the pixel movement amount calculator 55, and calculate a correction value of the first vehicle movement amount Lp. The movement amount corrector 57 may also use the second vehicle movement amount Lf as the third vehicle movement amount Lc, and in this case, the calculation of the third vehicle movement amount Lc may be omitted and the first vehicle movement amount Lp may be replaced with the second vehicle movement amount Lf. The movement amount corrector 57 may be included in the vehicle movement amount calculator 53.

When the movement amount corrector 57 calculates the movement amount correction value to correct the movement amount, the correction can be performed by the following method. For example, the movement amount corrector 57 may calculate a correction gain Lf/Lp from the first vehicle movement amount Lp and the second vehicle movement amount Lf, and multiply the first vehicle movement amount Lp by this correction gain Lf/Lp to obtain the corrected third vehicle movement amount Lc. In addition, the movement amount corrector 57 may calculate a correction difference (Lf−Lp) from the first vehicle movement amount Lp and the second vehicle movement amount Lf, and add this correction difference (Lf−Lp) to the first vehicle movement amount Lp to obtain the corrected third vehicle movement amount Lc.

When calculating the correction gain Lf/Lp, the first movement velocity Vp detected by the correction processor 33 based on the pulse signal of the vehicle velocity sensor 4 can be multiplied by the correction gain Lf/Lp to perform correction at the velocity calculation stage.

Since the movement amount corrector 57 calculates the correction gain Lf/Lp every time the pulse signal generator 4a generates a pulse signal, the average value of these calculated correction gains may be used as the correction gain, or the correction gain calculated at a predetermined timing may be used as the correction gain. As for this predetermined timing, the first timing is when the changes in both the image and the movement amount calculated by the vehicle velocity sensor 4 are equal to or smaller than a predetermined threshold, and the second timing is when the vehicle vibration detected by a vibration detector of the vehicle 3 is equal to or smaller than a predetermined threshold.

A movement velocity corrector 59 calculates the movement velocity of the vehicle 3 based on the vehicle movement amount corrected by the movement amount corrector 57, thereby obtaining a second movement velocity Vf obtained by correcting the first movement velocity Vp detected by the correction processor 33 based on the pulse signal of the vehicle velocity sensor 4. The movement velocity corrector 59 can obtain the corrected second movement velocity Vf, for example, by dividing the second vehicle movement amount Lf corrected from the first vehicle movement amount Lp by the inter-pulse time Tr.

The storage 15 is a storage medium that stores programs and data necessary to implement the functions of the correction processor 33. The storage 15 can be implemented by, for example, a hard disk drive (HDD), an SSD, a RAM, a DRAM, a ferroelectric memory, a flash memory, a magnetic disk, or a combination thereof.

An operation part 7 is an input for a user to give instructions to the correction processor 33. The operation part 7 may be an input dedicated to the imaging system 1, or may be a mobile terminal such as a smartphone. When a mobile terminal is used as the operation part 7, the operation part 7 and the correction processor 33 transmit and receive data via wireless communication. The user may use the operation part 7 to indicate whether the imaging target area is a dark area indoors such as a tunnel, or a bright area outdoors such as a mountain slope. When imaging at a fixed time interval, the user may use the operation part 7 to indicate a frame rate Tf. The operation part 7 also has a display 8, which displays warnings from the imaging system 1 to notify the user. The operation part 7 is, for example, a touch panel display.

### 2. Action of Imaging System

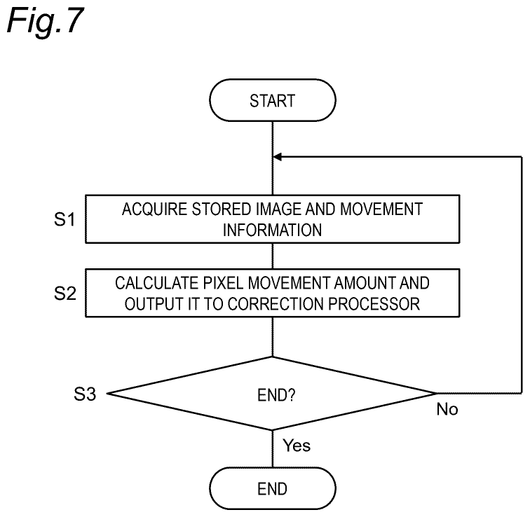

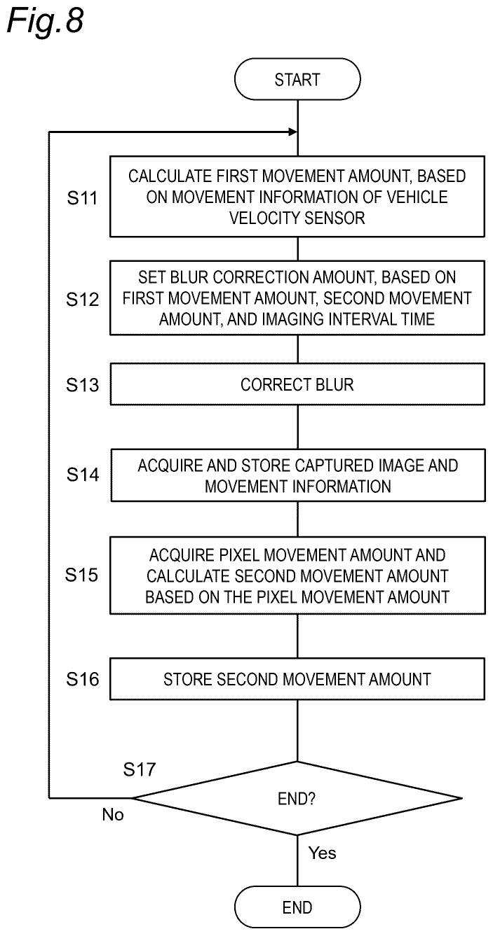

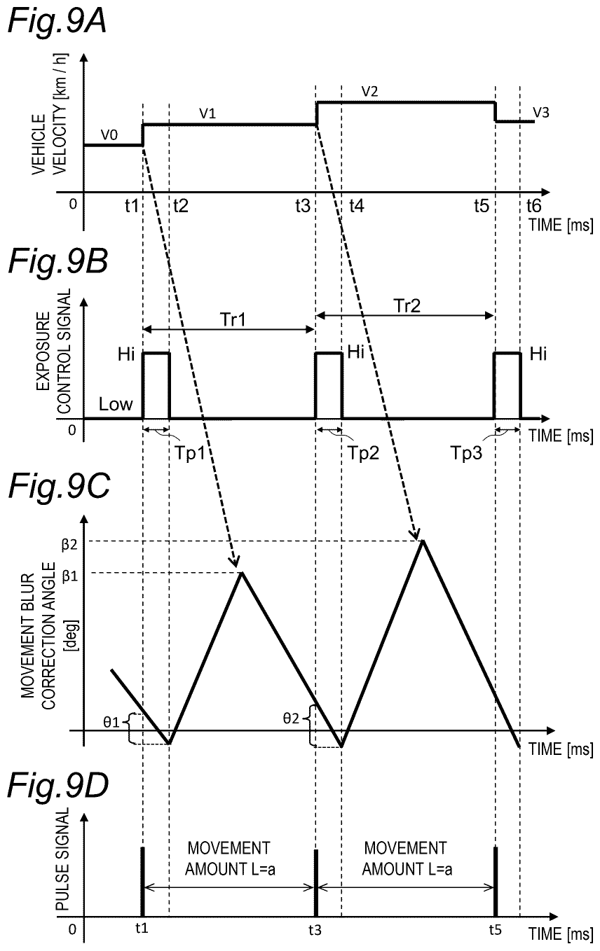

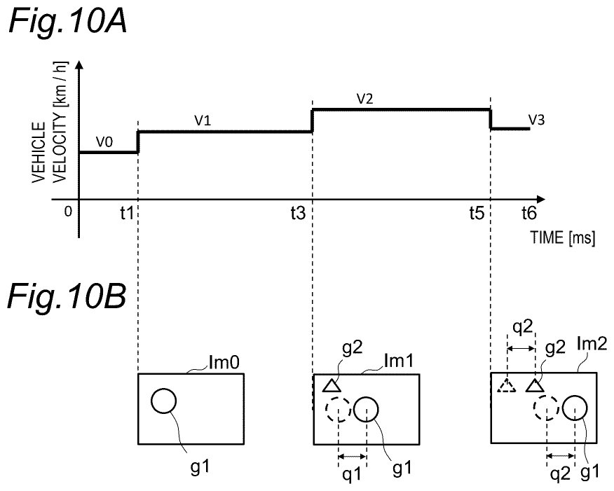

The action of the imaging system 1 of this embodiment will then be described with reference to FIGS. 7 to 10. FIG. 7 is a flowchart showing the action of the image processor. FIG. 8 is a flowchart showing the blur correction process performed by the imaging system 1 of the first embodiment. FIGS. 9A to 9D are graphs showing the relationship between changes in vehicle velocity, timings of the exposure time, motion blur correction angles, and pulse signals. FIG. 9A is a graph showing the movement velocity of the vehicle 3 changing over time. FIG. 9B is a graph showing the exposure time and the exposure timing for each frame. FIG. 9C is an explanatory view showing the motion blur correction angle calculated for each frame. FIG. 9D is a graph showing the timing at which the pulse signal is output. FIGS. 10A and 10B are explanatory views showing the relationship between changes in vehicle velocity and images captured for each frame. FIG. 10A is a graph showing the movement velocity of the vehicle 3 changing over time. FIG. 10B is an explanatory view showing the image captured for each frame.

When a user issues an instruction to start imaging to the imaging system 1 via the operation part 7, the imager 11 captures a plurality of images in sequence over time in synchronization with the pulse signal output from the pulse signal generator 4a.

When motion blur correction is started, as described above, at a certain point in time, a Hi signal indicating an image capture command is sent and the first image is captured. The motion blur correction at this time is performed using the first movement velocity Vp of the vehicle 3 detected by the correction processor 33 based on the pulse signal of the vehicle velocity sensor 4 of the previous frame. The blur correction amount calculator 51 calculates the motion blur correction angle for the next frame using the velocity V0 which is the first movement velocity Vp of the vehicle 3.

When the first image is captured, the mirror driver 43 drives the mirror 41 to a rotation start angle β1 in the motion blur correction direction. The dashed lines extending diagonally from FIGS. 9A to 9C indicate that the motion blur correction amount and the rotation start angle β1 in the correction direction of the first captured image are determined based on the velocity V0 at the time of exposure of the previous frame, and the motion blur correction amount and a rotation start angle β2 in the correction direction of the second captured image are determined based on the movement velocity V1 at the time of exposure of the first image. Note that FIG. 9C shows the blur correction angle, which is an optical angle, and therefore the mirror mechanical angle when the mirror 41 is used is H=2 in Equation (7) as described above, and is therefore half the size of each of the rotation start angles β1 and β2 in the correction direction.

As shown in FIGS. 9 and 10, the mirror driver 43 starts to rotate the mirror 41 in the direction for blur correction at the rotation velocity calculated by the blur correction amount calculator 51. The correction processor 33 sends the Hi signal indicating an image capture instruction to the camera controller 27, and an image is captured. At this time, the first image is blur corrected at a motion blur correction angle θ1 corresponding to a velocity V0 at which the immediately previous image was captured, and the second image is blur corrected at a motion blur correction angle θ2 corresponding to the movement velocity V1 at which the first image was captured.

The blur correction amount calculator 51 of the correction processor 33 calculates and sets the motion blur correction angle θ, which is a blur correction amount, based on a predetermined subject distance D, movement velocity V1, and exposure time Tp stored in the storage 15. The correction processor 33 calculates the mirror swing angle α based on the set motion blur correction angle θ, and calculates a mirror rotation velocity based on the calculated mirror swing angle α and the set exposure time Tp.

The correction processor 33 further rotates the mirror 41 at the calculated mirror rotation velocity, so that the mirror 41 starts rotating from a predetermined initial angle, thereby correcting blurring during image capture by the imager 11. The correction processor 33 also continues to send the Hi signal instructing exposure to the camera controller 27 for the exposure time Tp, for example, simultaneously with the generation of a pulse signal as movement information from the vehicle velocity sensor 4.

In the imager 11, the camera controller 27 acquires a first frame image Im0 by opening the shutter 24 and exposing it while receiving the Hi signal, and the correction processor 33 acquires movement information of the vehicle 3 between the imaging frames from the vehicle velocity sensor 4.

When the exposure time Tp has elapsed, the correction processor 33 continues to send a Low signal to the camera controller 27 to instruct the camera controller 27 to stop exposure. While the camera controller 27 is receiving the Low signal, the shutter 24 is closed, and the correction processor 33 causes the mirror drive 43 to rotate the mirror 41 in the reverse direction to move the mirror 41 to the rotation start positions β1 and β2 for the next blur correction. The rotation start positions β1 and β2 vary depending on the movement velocity V1 of the vehicle 3, the subject distance D, and the exposure time Tp. The mirror drive 43 may also rotate the mirror 41 in the forward direction to move the mirror 41 to the rotation start positions β1 and β2 for the next blur correction.

The correction processor 33 starts imaging processing an image Im1 of the next frame, for example, a second frame. In the imaging processing of the second frame, the blur correction amount calculator 51 sets the motion blur correction angle θ, which is the blur correction amount, based on the subject distance D, the movement velocity V1, and the exposure time Tp. After this, the same imaging processing as for the first frame is performed, and the imager 11 captures the image Im1 of the second frame shown in FIG. 10B. The captured image Im1 is stored in the storage 15.

Since the two images Im0 and Im1 are stored in the storage 15, the pixel movement amount calculator 55 calculates the pixel movement amount pb between two or more images, and the vehicle movement amount calculator 53 calculates a first vehicle movement amount Lp by which the vehicle 3 has moved from the start of imaging of the current imaging frame to the start of imaging of the next imaging frame from the acquired movement information. The calculated first vehicle movement amount Lp is stored in the storage 15 in association with the captured image.

A common feature portion g1 is captured in the images Im0 and Im1, and the image processor 14 detects a pixel movement amount q1 between the images Im0 and Im1 by image matching processing. The second vehicle movement amount Lf of the vehicle 3 between the captured frames is calculated based on the pixel movement amount q1, the pixel pitch s, and the subject magnification M.

An image Im2 of the next frame, for example, a third frame is captured. In the imaging process for the third frame, the blur correction amount calculator 51 sets the blur correction amount using the second movement velocity Vf, which is the movement velocity of the vehicle 3 corrected by the movement amount corrector 57 and the movement velocity corrector 59. After this, the same imaging process as for the second frame is performed, and the imager 11 captures the second image Im2 of the third frame shown in FIG. 10B. Since the blur correction for the second image Im2 of the third frame has been performed with higher accuracy, the blur correction is improved compared to the image Im0 of the first frame and the image Im1 of the second frame. The captured image Im2 is stored in the storage 15.

The image processor 14 detects a pixel movement amount q2 of the common feature portion g1 captured in the second frame image Im1 and the third frame image Im2. The pixel movement amount calculator 55 converts this pixel movement amount q2 from pixel units to um units, and the movement amount corrector 57 calculates the second vehicle movement amount Lf from the pixel movement amount q2 converted to um units. The movement velocity corrector 59 calculates the second movement velocity Vf based on the second vehicle movement amount Lf, and the blur correction amount calculator 51 can accurately set the movement blur correction angle θ of the next captured image Im3 based on the second movement velocity Vf, thereby further improving the accuracy of blur correction.

The flow of the action of the image processor will be described with reference to FIG. 7. The image processing action of the image processor 14 is started at any timing. The start timing may be, for example, when the action of the imaging system is started, or when the second captured image captured by the imager is stored in the storage 15.

When the image processing action is started, at step S1, the image processor 14 acquires the image and movement information stored in the storage 15. Next, at step S2, the image processor 14 calculates the pixel movement amount pb and outputs it to the correction processor 33. When the image processor 14 outputs the pixel movement amount pb a predetermined number of times, the image processor 14 satisfies the end condition of the image processing action. At step S3, if this end condition is satisfied (Yes at step S3), the image processing action ends, and if the end condition is not satisfied (No at step S3), the process from step S1 is repeated.

The blur correction process performed by the imaging system 1 will then be described with reference to FIG. 8. At step S11, the vehicle movement amount calculator 53 calculates a first vehicle movement amount Lp as the vehicle movement amount La based on a pulse signal as movement information from the vehicle velocity sensor 4. The vehicle 3 starts traveling, and the vehicle movement amount calculator 53 detects the movement velocity of the vehicle 3 based on the first vehicle movement amount Lp. In this embodiment, imaging is performed in synchronization with the pulse signal generator 4a of the vehicle velocity sensor 4 outputting a pulse signal. When the exposure is synchronized with the pulse signal, for example, if the moving distance of the vehicle 3 is 40 cm and the pulse signal is output at intervals, the frame rate becomes about 40 fps when the traveling velocity is 60 km/h. Note that instead of outputting the pulse signal to the correction processor 33, the vehicle velocity detected based on the pulse signal may be output to the correction processor 33. Movement information including the pulse signal is sent from the vehicle velocity sensor 4 to the correction processor 33. Note that the distance interval for velocity detection may be changed according to the specifications of the pulse signal generator 4a.

At step S12, the blur correction amount calculator 51 sets the blur correction amount based on the first vehicle movement amount Lp, the second vehicle movement amount Lf, and the imaging interval. If the second vehicle movement amount Lf has not been calculated, the blur correction amount is set based on the first vehicle movement amount Lp and the imaging interval. The blur correction amount calculator 51 calculates the mirror swing angle a as the blur correction amount by the above method.

At step S13, the imager 11 captures an image of the image capture area while the blur corrector 13 performs image blur correction. The image blur correction amount calculator 51 calculates the rotation velocity Vm of the mirror 41 based on the mirror swing angle α. The correction processor 33 causes the mirror drive 43 to rotate the mirror 41 at the calculated rotation velocity Vm, so that the mirror 41 starts to rotate from the predetermined initial angle. This performs motion blur correction during image capture by the imager 11. In addition, the correction processor 33 continues to send the Hi signal instructing exposure to the camera controller 27 for the exposure time Tp at the timing when the pulse signal from the vehicle velocity sensor 4 is updated (ON).

In the imager 11, the camera controller 27 acquires an image by opening the shutter 24 to expose the camera while receiving the Hi signal, and stores the acquired image in the storage 15. When the exposure time Tp has elapsed, the correction processor 33 continues to send the Low signal as an OFF signal that instructs the camera controller 27 to stop exposure. Note that the Low signal may be used as an ON signal that instructs exposure, and the Hi signal may be used as an OFF signal that instructs the camera controller 27 to stop exposure.

While the camera controller 27 is receiving the Low signal, it closes the shutter 24, and the correction processor 33 causes the mirror drive 43 to rotate the mirror 41 in the opposite direction to move the mirror 41 to the rotation start positions β1 and β2 for the next blur correction. The mirror drive 43 may also rotate the mirror 41 in the forward direction to move the mirror 41 to the rotation start positions β1 and β2 for the next blur correction. The time when the mirror 41 is located at the rotation start position is the beginning of one cycle of motion blur correction, and the length of one cycle of motion blur correction is the time until the mirror 41 moves to the next rotation start position.

At step S14, the imager 11 acquires the captured image and the movement information at the time of capturing the image, and stores them in the storage 15 in association with each other.

At step S15, the correction processor 33 acquires the pixel movement amount pb output from the image processor 14 at step S2 of FIG. 7, and the movement amount corrector 57 calculates the second vehicle movement amount Lf, which is the movement amount of the vehicle 3 obtained from image processing, based on the pixel movement amount pb.

At step S16, the movement amount corrector 57 stores the second vehicle movement amount Lf in the storage 15.

At step S17, the correction processor 33 determines whether the end condition of the blur correction process is satisfied. The end condition of the blur correction process is, for example, when an instruction to end imaging is given from the operation part 7, or when imaging of the entire area of the planned imaging target is completed. If the correction processor 33 determines that the end condition of the blur correction process is satisfied (Yes at step S17), it ends the blur correction process. If the correction processor 33 determines that the end condition of the blur correction process is not satisfied (No at step S17), it repeats the processing from step S11 again.

### 3. Effects, Etc.

In this way, the imaging system 1 is installed on the vehicle 3 and captures an image of an imaging target that is at least a part of the surroundings of the vehicle 3 away from the moving object 3. The imaging system 1 includes the imager 11 that captures images of the imaging target in time series to obtain plural images, a blur corrector 13 that obtains movement information of the vehicle 3 and corrects blur in the movement direction during imaging by the imager 11, and an image processor 14 that calculates the amount of pixel movement of a common area in the plural images. Based on the movement information and the amount of pixel movement obtained from the image processor 14, the blur corrector 13 corrects blur during exposure when the imager 11 captures the next image to be captured.

In the past, there were cases where images could not be captured at a constant distance due to non-dependency on the velocity, or where the amount of movement required for image blur correction could only be calculated after capturing an image. In the case of constant detection of the amount of movement, a large image processing load was imposed, requiring a system scale commensurate with the processing capacity.

According to the above imaging system 1, by utilizing the blur-corrected captured image used for image measurement, it is possible to correct an error in the vehicle velocity detected based on the pulse signal of the vehicle velocity sensor 4 without adding a highly accurate and expensive device such as the vehicle speedometer. Furthermore, it is possible to obtain a clear captured image by highly accurate blur correction in the moving direction.

Since the error in the amount of movement, which is the standard value of the vehicle velocity sensor 4, is corrected with a value calculated from the captured image, the amount of movement of the vehicle 3 can be accurately detected even when weight changes due to the number of occupants, remaining gasoline, or weight of cargo in the vehicle 3, or changes in tire air pressure occur. While the traveling velocity of the vehicle 3 changes from time to time, the amount of movement of the vehicle velocity sensor 4, which is a fixed value, is corrected, so the amount of movement can be corrected irrespective of changing traveling conditions, and correction of the amount of movement can be performed plural times while traveling. The amount of movement can be detected with high accuracy, and as a result, the traveling velocity of the vehicle 3, which changes from time to time, can be accurately detected.

### Second Embodiment

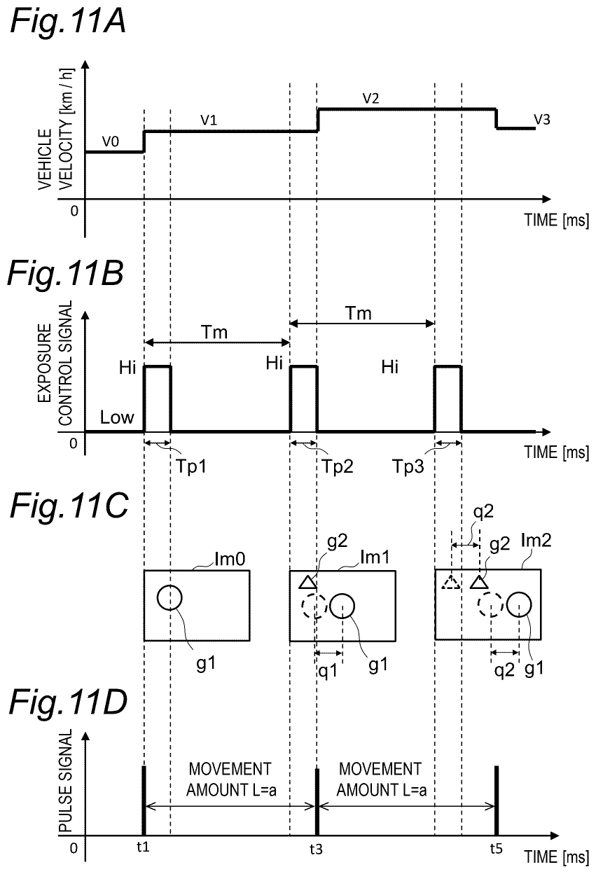

A second embodiment will then be described with reference to FIGS. 11A to 11D. FIGS. 11A to 11D are explanatory views explaining imaging in the second embodiment. In the first embodiment, imaging of a subject is performed in synchronization with the output timing of a pulse signal. In the second embodiment, imaging is performed at a predetermined frame rate. Hence, in the second embodiment, the output timing of a pulse signal and the imaging timing are not synchronized. In this respect and other points to be described below, the imaging system 1 in the second embodiment is the same as the imaging system 1 in the first embodiment, and therefore description of the common configuration will be omitted.

The movement amount corrector 57 in the second embodiment calculates a first movement amount per unit time (Lp/Tp) from the first vehicle movement amount Lp and the inter-pulse time Tr, which is the time interval between pulse signals, based on the inter-pulse time Tr. The movement amount corrector 57 also calculates a second movement amount per unit time (Lf/Tm) from the imaging interval time Tm for acquiring two images and the second vehicle movement amount Lf.

Since the image processing and the calculation timing of the vehicle velocity sensor are not synchronized, it is necessary to associate the acquisition time of the image data with the acquisition time of the vehicle velocity data. Hence, the movement amount corrector 57 calculates a movement amount correction value Ca from the first movement amount per unit time (Lp/Tp) and the second movement amount per unit time (Lf/Tm) acquired within the same time range by following Equation (11).

$$\begin{matrix}Ca = ( Lf [ mm ] / Tm [ ms ] ) / ( Lp [ mm ] / Tp [ ms ] ) \\ = ( Lf [ mm ] / \times Tp [ ms ] ) / ( Lp [ mm ] \times Tm [ ms ] )\end{matrix} \qquad Eq . ( 11 )$$

The movement amount corrector 57 further corrects the first vehicle movement amount Lp using the calculated movement amount correction value Ca, and calculates a corrected third vehicle movement amount Lc by following Equation (12).

$$\begin{matrix}Lc [ mm ] = Lp [ mm ] \times Ca \\ = Lp [ mm ] \times ( Lf [ mm ] \times Tp [ ms ] ) / ( Lp [ mm ] \times Tm [ ms ] ) \\ = ( Lf [ mm ] \times Tp [ ms ] ) / Tm [ ms ]\end{matrix} \qquad Eq . ( 12 )$$

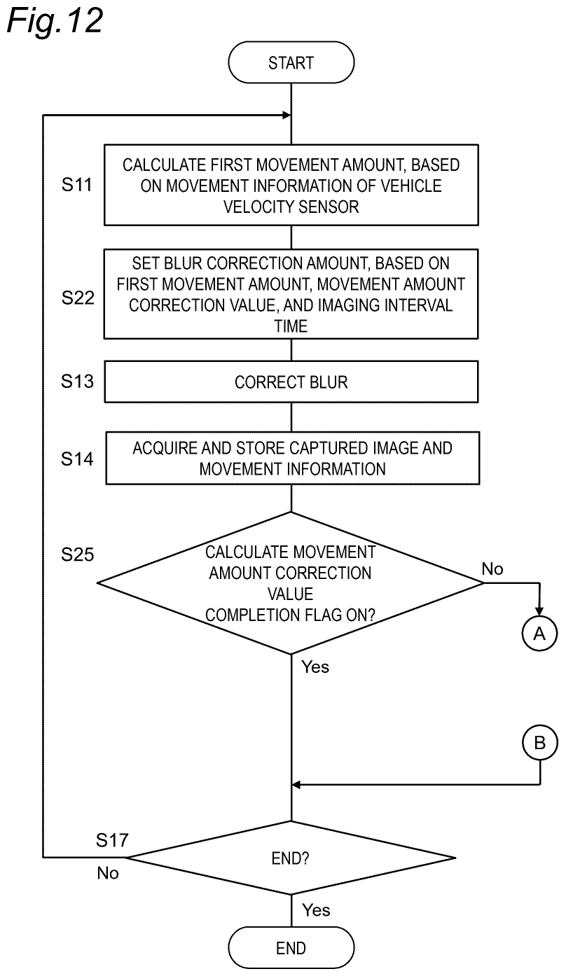

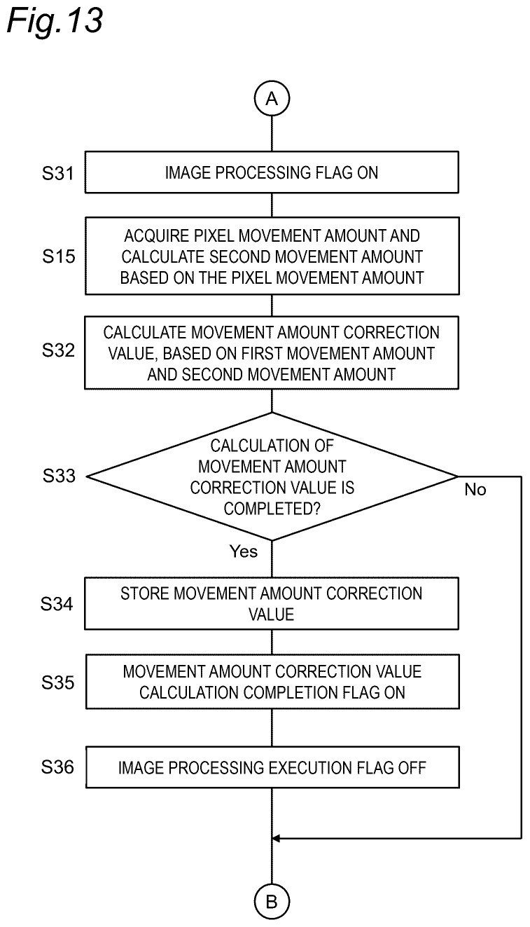

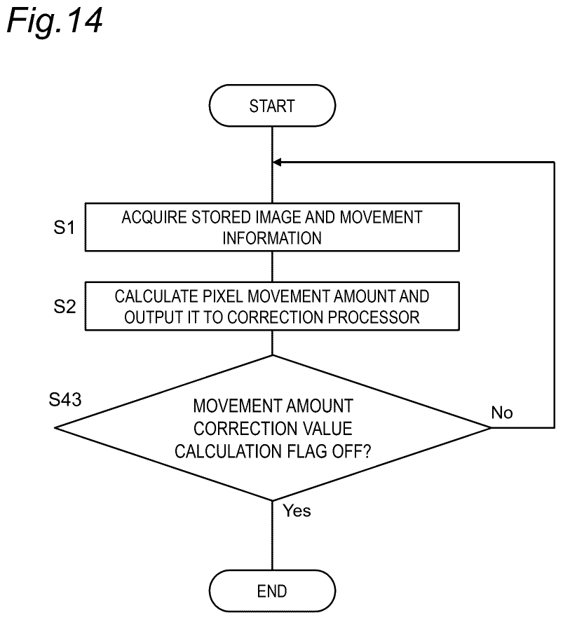

The action of the imaging system 1 of this embodiment will next be described with reference to FIG. 12 to FIG. 14. FIG. 12 and FIG. 13 are flowcharts showing the blur correction process performed by the imaging system 1 of the second embodiment. FIG. 14 is a flowchart showing the action of the image processor 14 of the second embodiment.

In the blur correction process in the second embodiment, step S11 is the same as in the first embodiment, so that the description will be omitted. At step S22, the blur correction amount calculator 51 sets the blur correction amount based on the first vehicle movement amount Lp, the movement amount correction value Ca, and the imaging interval time Tm. If the movement amount correction value Ca has not been calculated, the blur correction amount is set based on the first vehicle movement amount Lp and the imaging interval time Tm. The blur correction amount calculator 51 calculates the mirror swing angle α as the blur correction amount in the same manner as in the first embodiment.

Then, at steps S13 and S14, as in first embodiment, the imager 11 captures the imaging area while the blur corrector 13 performs image blur correction, and the imager 11 acquires the captured image and movement information at the time of image capture, associates them with each other, and stores them in the storage 15.

At step S25, the correction processor 33 determines whether the movement amount correction value calculation completion flag is ON. When the correction processor 33 determines that the movement amount correction value calculation completion flag is ON (Yes at step S25), the correction processor 33 executes step S17, and determines whether the end condition of the blur correction process is satisfied, as in the first embodiment. When the correction processor 33 determines that the movement amount correction value calculation completion flag is not ON (No at step S25), the correction processor 33 executes step S31 in FIG. 13.

At step S31, the correction processor 33 turns on the image processing flag. When the image processing flag is turned on, the image processor 14 starts the image processing action shown in FIG. 14. When step S2 shown in FIG. 14 is executed and the pixel movement amount is transmitted from the image processor 14 to the correction processor 33, the vehicle movement amount calculator 53 calculates the second vehicle movement amount Lf at step S15, similarly to the first embodiment.

At step S32, the movement amount corrector 57 calculates the movement amount correction value Ca based on the first vehicle movement amount Lp and the second vehicle movement amount Lf. When capturing an image of a subject at a fixed frame rate, the movement amount correction value Ca is calculated based on the movement amount per unit time of each of the first vehicle movement amount Lp and the second vehicle movement amount Lf, as described above.

At step S33, the movement amount corrector 57 of the correction processor 33 determines whether the calculation of the movement amount correction value Ca is completed. If the movement amount corrector 57 determines that the calculation of the movement amount correction value Ca is not completed correctly (No at step S33), the process returns to step S17 in FIG. 12. Then, since the calculation of the movement amount correction value Ca is not completed, that is, the end condition of the blur correction process is not satisfied (No at step S17), the movement amount corrector 57 executes steps S11, S22, S13, S14, and S25, and executes the calculation of the movement amount correction value Ca again from step S31.

At step S33, when the movement amount corrector 57 of the correction processor 33 determines that the calculation of the movement amount correction value Ca is completed (Yes at step S33), the movement amount corrector 57 stores the calculated movement amount correction value Ca in the storage 15 at step S34.

At step S35, when the calculation of the movement amount correction value Ca is completed, the movement amount corrector 57 sets a movement amount correction value calculation completion flag to ON.

At step S36, when the movement amount correction value calculation completion flag is set to the ON state, the correction processor 33 sets the image processing execution flag to OFF, and executes step S17 in FIG. 12 in the same manner as in the first embodiment.

The process from steps S31 to S36 shown in FIG. 13 basically needs to be performed only once at the beginning, so long as the movement amount correction value Ca can be calculated.

Reference is made to FIG. 14. The action of the image processor 14 in the second embodiment will be described. When the image processing flag is ON, the image processor 14 starts the image processing action. Steps S1 and S2 are the same as those in the first embodiment, and therefore the description will be omitted. At step S43, it is determined whether a movement amount correction value calculation flag set by the correction processor 33 is OFF. If the image processor 14 determines that the movement amount correction value calculation flag is OFF (Yes at step S43), the image processing action ends. If the image processor 14 determines that the movement amount correction value calculation flag is not OFF (No at step S43), the process from step S1 is repeated. If the movement amount correction value calculation flag is OFF (Yes at step S43), the action of the image processor can be ended. By ending the action of the image processor, the load on the image processing can be reduced.

In this way, when the image processing execution flag is ON, the calculation processing action of the pixel movement amount pb of the image processor 14 is started, so that it is not necessary to perform the processing at all times while the vehicle 3 is traveling, and real-time processing is also not required. The calculation processing action of the pixel movement amount pb is performed only when the movement amount correction value is calculated, and when the movement amount correction value calculation flag is turned OFF, the detection processing action of the pixel movement amount pb is also terminated, so that the load of image processing can be reduced.

Thus, according to the second embodiment, the movement amount corrector 57 converts the movement amount correction value Ca into data, thereby making it possible to omit the subsequent calculation process of the pixel movement amount pb, and reducing the load on the image processor 14.

### Third Embodiment

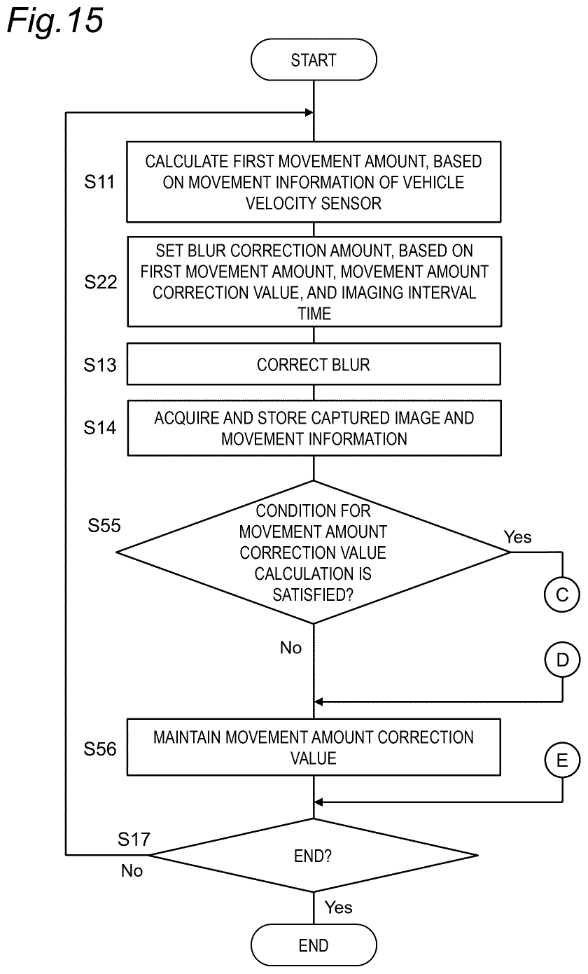

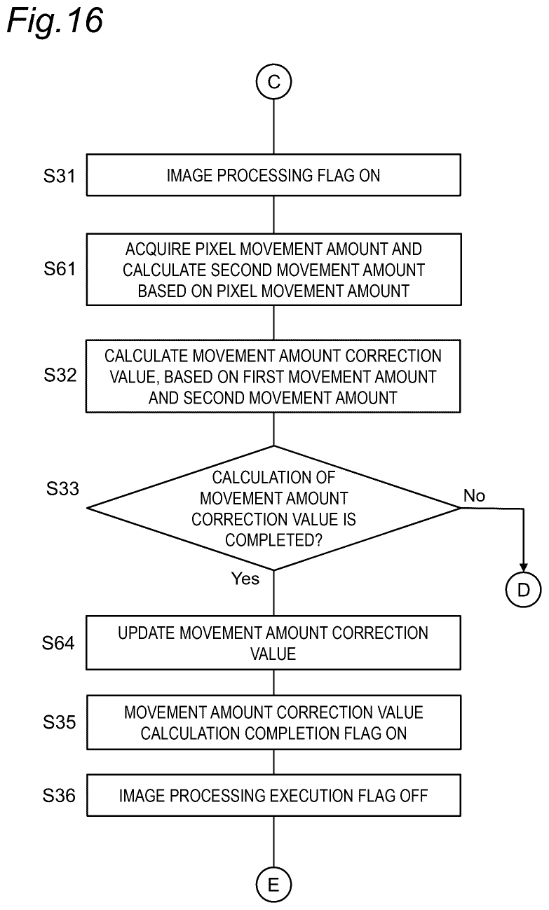

The action of the imaging system 1 of a third embodiment will next be described with reference to FIGS. 15 and 16. FIGS. 15 and 16 are flowcharts showing the blur correction process performed by the imaging system 1 of the third embodiment. Except for the points described below, the imaging system 1 of the third embodiment is the same as the imaging system 1 of the second embodiment, and description of the common configuration will be omitted.

As for the blur correction process in the third embodiment, the processes at steps S11, S22, S13, and S14 are similar to those in the second embodiment, and therefore the description thereof will be omitted.

At step S55, the movement amount corrector 57 determines whether the condition for calculating the movement amount correction value is satisfied. The conditions for calculating the movement amount correction value include, for example, the following six conditions. A first condition is that the number of times of calculation of the movement amount correction value Ca after the start of the imaging system 1 is equal to or less than a predetermined threshold. A second condition is that the elapsed time after startup of the imaging system 1 is within a predetermined time period. A third condition is that the amount of change in the first vehicle movement amount Lp and the second vehicle movement amount Lf is equal to or greater than a predetermined threshold. A fourth condition is that the total movement distance of the vehicle 3 after the calculation of the previous movement amount correction value Ca is equal to or greater than a predetermined threshold. A fifth condition is that the elapsed time after the calculation of the previous movement amount correction value Ca is within a predetermined time period. A sixth condition is that the amount of fuel used after the calculation of the previous movement amount correction value Ca is equal to or less than a predetermined threshold. The conditions for calculating the movement amount correction value may be any one of these six conditions or a combination thereof. If the movement amount corrector 57 determines that the condition for calculating the movement amount correction value set in this manner is satisfied (Yes at step S55), step S31 in FIG. 16 is executed in the same manner as in the second embodiment, and the image processing flag is set to ON.

In the third embodiment, a condition for calculating the movement amount correction value is set, and it is determined whether the condition is satisfied. Hence, dissimilar to the second embodiment, the calculation of the movement amount correction value Ca in the third embodiment is executed plural times.

At step S61, the process may be performed in the same manner as step S15 in the second embodiment, or the second vehicle movement amount Lf may be calculated using a plurality of pixel movement amounts pb. For example, the image processor 14 calculates pixel movement amounts pb of characteristic parts common to a k^{th} image (k=an integer from 1 to n) and a (k+1)^{th} image. The movement amount corrector 57 calculates the movement amount correction value Ca for correcting a k^{th} first vehicle movement amount Lp based on the k pixel movement amounts pb calculated by the image processor 14 up to that point. The movement amount corrector 57 further corrects blurring during imaging when the imager 11 captures a (k+2)^{th} image based on the k^{th} first vehicle movement amount Lp, the movement amount correction value Ca, and the imaging interval time Tm between the (k+1)^{th} image and the (k+2)^{th} image. In this embodiment, the imaging method is described as fixed frame rate imaging, but pulse signal synchronous imaging may also be used.

When calculating the movement amount correction value Ca, the movement amount corrector 57 may calculate the movement amount correction value Ca by excluding pixel movement amounts pb whose difference from the average value of the k pixel movement amounts pb calculated by the image processor 14 up to that point is equal to or greater than a predetermined threshold value.

Steps S32 and S33 are executed in the same manner as in second embodiment. At step S33, if the movement amount corrector 57 determines that the calculation of the movement amount correction value Ca has not been completed correctly (No at step S33), and if the movement amount corrector 57 determines at step S55 of FIG. 15 that the conditions for calculating the movement amount correction value are not satisfied (No at step S55), at step S56, the movement amount corrector 57 maintains the movement amount correction value Ca stored in the storage 15. Step S17 is then executed in the same manner as in second embodiment.

When it is determined at step S33 of FIG. 16 that the calculation of the movement amount correction value Ca has been correctly completed (Yes at step S33), the movement amount corrector 57 updates the movement amount correction value Ca at step S64 by storing the calculated movement amount correction value Ca in the storage 15. The correction processor 33 notifies the driver by displaying on the display that the movement amount correction value Ca has been updated.

Steps S35 and S36, and step S17 of FIG. 15 are then executed in the same manner as in the second embodiment.

As described above, according to the third embodiment, since the standard value of the vehicle velocity sensor 4, which is a fixed value that does not depend on the velocity change, is corrected, the correction can be performed plural times even while the vehicle is traveling changing the vehicle velocity. This makes it possible to improve the accuracy of the calculation of the correction value by averaging or removing abnormal values.

Conventionally, when an image is blurred due to disturbance vibrations or the like, the accuracy of movement amount detection decreases, and when the accuracy of movement amount detection decreases, the accuracy of blur correction also decreases, resulting in a negative loop. However, according to the third embodiment, even if image blur occurs, the accuracy of correction value calculation and motion blur correction can be gradually improved by performing a loop process of correction value calculation that is performed in the order of correction value calculation by image processing, motion blur correction, and image processing.

### Fourth Embodiment

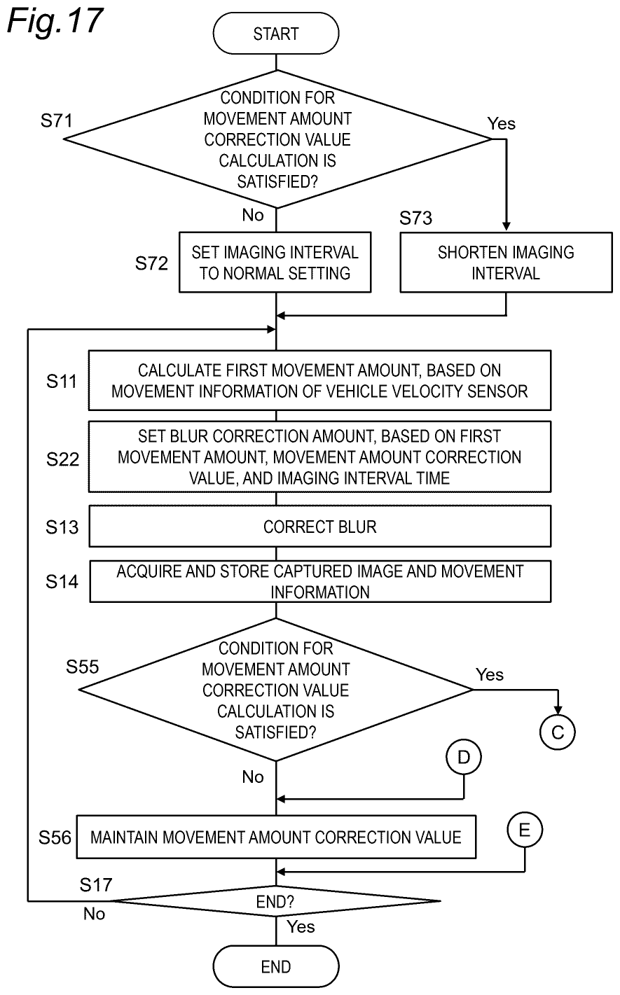

The action of the imaging system 1 of a fourth embodiment will next be described with reference to FIG. 17. FIG. 17 is a flowchart showing the blur correction process performed by the imaging system 1 of the fourth embodiment. The imaging system 1 of the fourth embodiment and the imaging system 1 of the third embodiment are the same in configuration and conditions for calculating the movement amount correction value other than those described below, and therefore description of the common configuration will be omitted.

In the blur correction process in the fourth embodiment, at step S71, the correction processor 33 determines whether the condition for calculating the movement amount correction value is satisfied, similarly to step S55 in the third embodiment. If the correction processor 33 determines that the condition for calculating the movement amount correction value is not satisfied (No at step S71), at step S72, the correction processor 33 instructs the camera controller 27 of the imager 11 to set the imaging interval time Tm to the normal setting. Hence, the imager 11 captures images at the normal frame rate.

When the correction processor 33 determines at step S71 that the condition for calculating the movement amount correction value is satisfied (Yes at step S71), at step S73, the correction processor 33 instructs the camera controller 27 of the imager 11 to make the imaging interval time Tm shorter than the normal setting. Hence, the imager 11 captures images at a frame rate higher than the normal frame rate.

The subsequent processing actions of the correction processor 33 and the image processor 14 at steps S11 to S17 are similar to those in the third embodiment, and therefore will not be described.

According to the fourth embodiment, when calculating the movement amount correction value Ca, the imaging interval between the two captured images is shortened to increase the overlapping portion between the two captured images, thereby improving the calculation accuracy of the pixel movement amount pb. This improves the calculation accuracy of the movement amount correction value Ca.

The correction process of the first vehicle movement amount Lp exemplified in the first to fourth embodiments may be performed when the vehicle 3 starts traveling and travels at a low velocity before reaching the imaging inspection area, or may be performed when traveling at a high velocity. The correction accuracy can be improved by performing (initializing) the correction of the first vehicle movement amount Lp when the vehicle 3 travels at a low velocity. The vehicle velocity of the low velocity travel in this initialization travel is, for example, 30 km/h or less.

When the calculation of the movement amount correction value Ca for low-velocity driving is completed, the correction processor 33 may notify the driver that the calculation of the movement amount correction value Ca has been completed by displaying on the display 8 that normal driving may be performed.

In the case where high-velocity driving is continued, for example, after driving a predetermined fixed distance or time, the imaging system 1 may again calculate the movement amount correction value Ca. In the first movement amount correction process, the movement amount correction value Ca may be calculated by fixed frame rate shooting, and the calculated movement amount correction value Ca may be used to correct the vehicle velocity by pulse signal synchronous imaging while driving.

The following six implementation patterns are possible depending on the combination of the imaging method and the timing of calculating the movement amount correction value. In a first pattern, during initialization driving in which the movement amount correction process is executed, the movement amount correction value is calculated by imaging synchronized with the pulse signal, and an inspection image is also acquired by imaging synchronized with the pulse signal during normal driving. In a second pattern, during initialization driving, the movement amount correction value is calculated by imaging synchronized with the pulse signal, and during normal driving, an inspection image is acquired by imaging synchronized with the pulse signal, and the movement amount correction value is calculated by imaging synchronized with the pulse signal.

In a third pattern, the movement amount correction value Ca is calculated by imaging at a fixed frame rate during initialization driving, and an inspection image is acquired by imaging synchronized with a pulse signal during normal driving. In a fourth pattern, the movement amount correction value Ca is calculated by imaging at a fixed frame rate during initialization driving, and an inspection image is acquired during normal driving, and the movement amount correction value is calculated by imaging synchronized with a pulse signal.

In a fifth pattern, the movement amount correction value Ca is calculated by fixed frame rate imaging during initialization driving, and an inspection image is also acquired by fixed frame rate imaging during normal driving. In a sixth pattern, the movement amount correction value Ca is calculated by fixed frame rate imaging during initialization driving, and an inspection image is also acquired by fixed frame rate imaging during normal driving, and the movement amount correction value Ca is calculated by fixed frame rate imaging.

The first to fourth patterns can reduce missed images and reduce storage shortages due to excessive image capture.

### Other Embodiments

As set forth hereinabove, the above embodiments have been described as exemplification of the technology disclosed in the present application. However, the technology in the present disclosure is not limited thereto, and is applicable to embodiments in which modifications, substitutions, additions, omissions, etc. are appropriately made. Thus, other embodiments will be exemplified below.

In the above embodiments, in three consecutive images, the pixel movement amount of the feature point by image matching of the first and second captured images is used to calculate the subject distance of the third image, but this is not limited to the above. If the image matching process of the two captured images lags behind the imaging cycle, the movement amount correction value Ca may be calculated several frames later.

In the above embodiments, the moving object is the vehicle 3 such as an automobile. However, the moving object is not limited to the vehicle 3, and may be a vehicle that runs on the ground such as a train or a motorcycle, a ship that travels on the sea, or an air vehicle such as an airplane or a drone that flies in the sky. When the moving object is a ship, the imaging system 1 images the bottom surface of a bridge pier or a bridge girder, or a structure constructed along a shore. When the moving object is a train, the deflection of the overhead line can be detected by imaging the overhead line. In addition, since the vehicle movement amount calculator 53 calculates the movement amount of the vehicle 3 as a moving object, when the moving object is something other than a vehicle, the vehicle movement amount calculator 53 calculates the movement amount of the moving object.

In the above embodiments, an image is captured using light that is the environmental light reflected on the imaging target area 9, but this is not limitative. Light may be irradiated from a moving object toward the imaging target area 9 so that an image is captured using reflected light of the irradiated light.

### Overview of Embodiments

(1) An imaging system of the present disclosure is an imaging system mounted on a moving object and capturing an image of an imaging target that is at least a part of surroundings of the moving object apart from the moving object, comprising: an imager that captures images of the imaging target over time to acquire a plurality of images; a blur corrector that acquires movement information of the moving object to correct blur along a movement direction that occurs in each of the plurality of images during exposure of the imager; and an image processor that calculates a pixel movement amount of a common area in the plurality of images. The blur corrector corrects blur along the movement direction during exposure when the imager captures a next image, based on the movement information and on the pixel movement amount acquired from the image processor.

Since blur correction is performed based not only on the movement information but also on the pixel movement amount acquired from the image processor, the accuracy of blur correction can be improved.
(2) In the imaging system of (1), the imager captures, as the plurality of images, a first image, a second image, and a third image in the mentioned order. The blur corrector calculates a first movement amount by which the moving object moves during an imaging interval between the first image and the second image, based on the movement information, calculates a second movement amount by which the moving object moves, based on the pixel movement amount between the first image and the second image acquired from the image processor, and corrects blur along the movement direction during exposure when the imager captures the third image, based on the first movement amount, the second movement amount, and an imaging interval between the second image and the third image.
(3) In the imaging system of (2), the blur corrector calculates a movement amount correction value for correcting the first movement amount, based on the second movement amount, and corrects blur along the movement direction during exposure when the imager captures the third image, based on the first movement amount, the movement amount correction value, and an imaging interval between the second image and the third image.
(4) In the imaging system of (3), the blur corrector calculates a subsequent first movement amount by which the moving object moves during an imaging interval between the second image and the third image, based on the movement information and the movement amount correction value, calculated a subsequent second movement amount by which the moving object moves, based on the pixel movement amount between the second image and the third image calculated by the image processor, calculates a second movement amount correction value for correcting the subsequent first movement amount, based on the subsequent second movement amount, and corrects blur along the movement direction during exposure when capturing a fourth image subsequent to the third image, based on the subsequent first movement amount, the movement amount correction value, and an imaging interval between the third image and the fourth image.
(5) In the imaging system of (3), the image processor calculates a pixel movement amount of the common area to a k^{th} image and a (k+1)^{th} image. The blur corrector calculates the movement amount correction value for correcting a k^{th} first movement amount, based on k pixel movement amounts, the blur corrector correcting blur along the movement direction during exposure when the imager captures a (k+2)^{th} image, based on the k^{th} first movement amount, the movement amount correction value, and an imaging interval between the (k+1)^{th} image and the (k+2)^{th} image.
(6) In the imaging system of (5), the blur corrector calculates the movement amount correction value by excluding pixel movement amounts whose difference from an average value of the k pixel movement amounts is equal to or greater than a threshold value.
(7) In the imaging system of (3), the blur corrector newly calculates and updates the movement amount correction value when a predetermined condition is met, and maintains the previously calculated movement amount correction value when the predetermined condition is not met.
(8) In the imaging system of (7), when the movement amount correction value is newly calculated, the imager shortens an imaging interval compared to when the previously calculated movement amount correction value is maintained.
(9) The imaging system of (7) comprises a notifier that notifies, when the blur corrector updates the movement amount correction value, that the movement amount correction value has been updated.
(10) In the imaging system of (7), the predetermined condition is that the number of times of calculation of the movement amount correction value after startup of the imaging system is equal to or less than a threshold value.
(11) In the imaging system of (7), the predetermined condition is to be within a predetermined time period after startup of the imaging system.
(12) In the imaging system of (7), the predetermined condition is that the amount of change between the first movement amount and the second movement amount is equal to or greater than a threshold value.
(13) In the imaging system of (7), the predetermined condition is that a total movement distance after the previous calculation of the movement amount correction value is equal to or greater than a threshold value.
(14) In the imaging system of (7), the predetermined condition is that the elapsed time after the previous calculation of the movement amount correction value is within a threshold time period.
(15) In the imaging system of (7), the predetermined condition is that the amount of fuel used after the previous calculation of the movement amount correction value is equal to or less than a threshold value.
(16) The imaging system of (7) comprises a vibration detection sensor for detecting vibrations of the moving object, wherein the predetermined condition is that the number of vibrations of the moving object detected by the vibration detection sensor is equal to or greater than a threshold value.
(17) In the imaging system of (2), the blur corrector calculates a movement amount per unit time of the first movement amount and the second movement amount, the blur corrector calculating a movement amount correction value for correcting the first movement amount, based on the movement amount per unit time of the first movement amount and the second movement amount.
(18) In the imaging system according to any one of (1) to (17), the imager sets an imaging interval so that the common area is captured in two consecutively captured images.

The imaging system described in the present disclosure is implemented by cooperation of hardware resources such as a processor, a memory, and a program.

The present disclosure is applicable to an imaging system mounted on a moving object.

### EXPLANATIONS OF LETTERS OR NUMERALS

1 imaging system
3 vehicle
3a tire
4 vehicle velocity sensor
4a pulse signal generator
5 tunnel
5a wall
5b hole
5c crack
7 operation part
8 display
9 imaging target area
11 imager
13 blur corrector
14 image processor
15 storage
17 correction processor
21 camera body
23 lens
24 shutter
25 imaging element
27 camera controller
31 blur correction assembly
33 correction processor
41 mirror
43 mirror drive
51 blur correction amount calculator
53 vehicle movement amount calculator
55 pixel movement amount calculator
57 movement amount corrector
59 movement velocity corrector
61 pixel resolution calculator
71 imaging element drive assembly
73 optical lens drive assembly
α mirror swing angle
Ca movement amount correction value
F focal length
La vehicle movement amount
Lp first vehicle movement amount
Lf second vehicle movement amount
Lc third vehicle movement amount
M subject magnification
V1 movement velocity
Vp first movement velocity
Vf second movement velocity
pb pixel movement amount

What is claimed is:

1. An imaging system mounted on a moving object and capturing an image of an imaging target that is at least a part of surroundings of the moving object apart from the moving object, comprising:
an imager that captures images of the imaging target over time to acquire a plurality of images;
a blur corrector that acquires movement information of the moving object to correct blur along a movement direction that occurs in each of the plurality of images during exposure of the imager; and
an image processor that calculates a pixel movement amount of a common area in the plurality of images,
the blur corrector correcting blur along the movement direction during exposure when the imager captures a next image, based on the movement information and on the pixel movement amount acquired from the image processor.

2. The imaging system according to claim 1, wherein
the imager captures, as the plurality of images, a first image, a second image, and a third image in the mentioned order, and wherein
the blur corrector includes:
calculating a first movement amount by which the moving object moves during an imaging interval between the first image and the second image, based on the movement information;
calculating a second movement amount by which the moving object moves, based on the pixel movement amount between the first image and the second image acquired from the image processor; and
correcting blur along the movement direction during exposure when the imager captures the third image, based on the first movement amount, the second movement amount, and an imaging interval between the second image and the third image.

3. The imaging system according to claim 2, wherein
the blur corrector includes:
calculating a movement amount correction value for correcting the first movement amount, based on the second movement amount; and
correcting blur along the movement direction during exposure when the imager captures the third image, based on the first movement amount, the movement amount correction value, and an imaging interval between the second image and the third image.

4. The imaging system according to claim 3, wherein
the blur corrector includes:
calculating a subsequent first movement amount by which the moving object moves during an imaging interval between the second image and the third image, based on the movement information and the movement amount correction value;
calculating a subsequent second movement amount by which the moving object moves, based on the pixel movement amount between the second image and the third image calculated by the image processor;
calculating a second movement amount correction value for correcting the subsequent first movement amount, based on the subsequent second movement amount; and
correcting blur along the movement direction during exposure when capturing a fourth image subsequent to the third image, based on the subsequent first movement amount, the movement amount correction value, and an imaging interval between the third image and the fourth image.

5. The imaging system according to claim 3, wherein
the image processor calculates a pixel movement amount of the common area to a k^{th} image and a (k+1)^{th} image, wherein
the blur corrector calculates the movement amount correction value for correcting a k^{th} first movement amount, based on k pixel movement amounts, the blur corrector correcting blur along the movement direction during exposure when the imager captures a (k+2)^{th} image, based on the k^{th} first movement amount, the movement amount correction value, and an imaging interval between the (k+1)^{th} image and the (k+2)^{th} image.

6. The imaging system according to claim 5, wherein
the blur corrector calculates the movement amount correction value by excluding pixel movement amounts whose difference from an average value of the k pixel movement amounts is equal to or greater than a threshold value.

7. The imaging system according to claim 3, wherein
the blur corrector newly calculates and updates the movement amount correction value when a predetermined condition is met, the blur corrector maintaining the previously calculated movement amount correction value when the predetermined condition is not met.

8. The imaging system according to claim 7, wherein
when the movement amount correction value is newly calculated, the imager shortens an imaging interval compared to when the previously calculated movement amount correction value is maintained.

9. The imaging system according to claim 7, comprising:
a notifier that notifies, when the blur corrector updates the movement amount correction value, that the movement amount correction value has been updated.

10. The imaging system according to claim 7, wherein
the predetermined condition is that the number of times of calculation of the movement amount correction value after startup of the imaging system is equal to or less than a threshold value.

11. The imaging system according to claim 7, wherein
the predetermined condition is to be within a predetermined time period after startup of the imaging system.

12. The imaging system according to claim 7, wherein
the predetermined condition is that the amount of change between the first movement amount and the second movement amount is equal to or greater than a threshold value.

13. The imaging system according to claim 7, wherein
the predetermined condition is that a total movement distance after the previous calculation of the movement amount correction value is equal to or greater than a threshold value.

14. The imaging system according to claim 7, wherein
the predetermined condition is that the elapsed time after the previous calculation of the movement amount correction value is within a threshold time period.

15. The imaging system according to claim 7, wherein
the predetermined condition is that the amount of fuel used after the previous calculation of the movement amount correction value is equal to or less than a threshold value.

16. The imaging system according to claim 7, comprising:
a vibration detection sensor for detecting vibrations of the moving object, wherein
the predetermined condition is that the number of vibrations of the moving object detected by the vibration detection sensor is equal to or greater than a threshold value.

17. The imaging system according to claim 2, wherein
the blur corrector calculates a movement amount per unit time of the first movement amount and the second movement amount,
the blur corrector calculating the movement amount correction value for correcting the first movement amount, based on the movement amount per unit time of the first movement amount and the second movement amount.

18. The imaging system according to claim 2, wherein
the imager sets an imaging interval so that the common area is captured in two consecutively captured images.
